(19) United States
(12) Patent Application Publication
(10) Pub. No.: US 2026/0030741 A1
(43) Pub. Date: Jan. 29, 2026

(54) MULTI-MODAL DEFECT INSPECTION

(71) Applicant: SAP SE, Walldorf (DE)

(72) Inventors: Xinyan Chen, Singapore (SG); Yinan He, Singapore (SG); Rajesh Vellore Arumugam, Singapore (SG); Anantharaman Ravi, Singapore (SG)

(21) Appl. No.: 18/785,622

(22) Filed: Jul. 26, 2024

(51) Int. Cl. G06T 7/00; G01N 21/88

(52) U.S. Cl. CPC G06T 7/001; G01N 21/8851; G01N 2021/8854; G01N 2021/8887

(57) ABSTRACT

Systems and methods described herein relate to multi-modal defect inspection. An image of an inspected item and structural imaging data of the inspected item are obtained. The image is captured by at least one optical sensor and the structural imaging data is obtained via at least one structural imaging sensor. The image is processed via a first machine learning model to obtain a first defect classification. At least some of the structural imaging data is processed via a second machine learning model to obtain a second defect classification. An inspection result is automatically generated based on the first defect classification and the second defect classification. The inspection result is caused to be presented at a user device in association with an item identifier of the inspected item.

### TECHNICAL FIELD

The subject matter disclosed herein generally relates to defect inspection and detection technology. More specifically, but not exclusively, the subject matter relates to systems and methods for multi-modal defect inspection.

### BACKGROUND

Defect inspection is an important part of many manufacturing or assembly processes. In the present context, defect inspection is often aimed at detecting items that have one or more physical defects, such as scratches, cracks, dents, or other problematic areas, or detecting erroneous construction (e.g., misaligned parts) or erroneous assembly (e.g., missing parts).

With advancements in technology, automated systems have been developed in an attempt to facilitate certain aspects of defect inspection. However, automated defect inspection presents various technical challenges. For example, factors such as occlusions formed by multiple items in an inspection area (e.g., on a conveyor belt), complex or intricate product designs, and varying lighting conditions can make it difficult to perform automated defect inspection in a sufficiently accurate and efficient manner.

### BRIEF DESCRIPTION OF THE DRAWINGS

Some examples are shown for purposes of illustration and not limitation in the figures of the accompanying drawings. In the drawings, which are not necessarily drawn to scale, like numerals may describe similar components in different views or examples. To identify the discussion of any particular element or act more easily, the most significant digit or digits in a reference number refer to the figure number in which that element is first introduced.

FIG. 1 is a diagrammatic representation of a network environment that includes a defect inspection system, according to some examples.

FIG. 2 is a block diagram of components of a defect inspection system, according to some examples.

FIG. 3 is a diagram illustrating inspection components in an inspection area, and further illustrating aspects of a process to generate an inspection result, according to some examples.

FIG. 4 is a flowchart illustrating operations of a method for multi-modal defect inspection, according to some examples.

FIG. 5 illustrates a confusion matrix, according to some examples.

FIG. 6 diagrammatically illustrates training and use of a machine learning program, according to some examples.

FIG. 7 is a block diagram showing a software architecture for a computing device, according to some examples.

FIG. 8 is a block diagram of a machine in the form of a computer system, according to some examples, within which instructions may be executed for causing the machine to perform any one or more of the methodologies discussed herein.

### DETAILED DESCRIPTION

Driven by the development and improvement of computer vision techniques, automatic visual inspection can be performed to check for problematic areas on certain items. However, automated defect inspection that relies on visual inspection alone presents technical challenges. For example, vision-based approaches often rely on high-quality images. In low-light scenarios, inadequate illumination can degrade the quality of images and thus the performance of a vision-based system. High-quality images can also take up significant amounts of storage space and can have relatively high transmission-related costs. This may result in a tradeoff between inspection accuracy and the cost of storing or transmitting data.

Furthermore, vision-based systems may be hampered by occlusion or self-occlusion issues. For example, multiple items might overlap within captured images, making it impossible to inspect all areas of the items using the vision modality alone. A camera is also usually set up to capture the items from a specific angle, thereby leaving potentially problematic areas uncaptured. Moreover, even if a vision-based system succeeds in capturing all relevant areas of the exterior of an item, vision-based approaches are not useful for detecting defects that are not observable from the outside (e.g., a missing screw of a part that is located inside of a product housing).

Systems and methods described herein relate to techniques for multi-modal defect inspection. Examples in the present disclosure address or alleviate technical challenges associated with single-modality inspection, such as defect inspection that uses only the vision modality, by employing an additional inspection modality as well as deep learning techniques for improved defect classification.

In some examples, defect inspection is structured as a binary classification problem where a system is configured to classify an inspected item as “defective” or “non-defective.” A multi-modal system, such as a system that employs an RGB (red, green, and blue) camera as a first sensing modality and an ultra-wideband (UWB) scanner, or UWB radar, as a second sending modality, can provide for improved technical performance with respect to such a binary classification problem.

An example method includes accessing one or more images of an inspected item and structural imaging data of the inspected item. Accordingly, the first modality may be an optical or vision modality, while the second modality is a structural imaging modality. The inspected item may be a product (e.g., an assembled product or manufactured product) or components thereof (e.g., sub-parts of the product). The one or more images may be captured by at least one optical sensor, such as a color camera (e.g., RGB camera) or depth sensor. A non-limiting example of an optical sensor is an RGB-D (RGB-Depth) camera, which provides depth and color data as output (e.g., a single frame with RGB data and depth information obtained via pixel-to-pixel merging). The structural imaging data may be obtained via at least one structural imaging sensor, such as a radar apparatus (e.g., UWB scanner, millimeter wave radar system, or synthetic aperture radar system (e.g., for dielectric items)) or ultrasonic inspection apparatus.

In some examples, the one or more images are processed via a first machine learning model to obtain a first defect classification, and at least some of the structural imaging data is processed via a second machine learning model to obtain a second defect classification. An inspection result is automatically generated based on the first defect classification and the second defect classification.

A “defect classification,” as used herein, may include a categorization, labeling, or flagging of data derived from analysis of an inspected item to determine the presence, type, or severity of a defect. Defect classification can be binary, indicating simply the presence or absence (or predicted presence or absence) of a defect. For example, an RGB camera captures images of a product on an assembly line, and these images are processed using a machine learning model that classifies the images into categories such as “defective” or “non-defective” based on the presence of surface defects. In some examples, a binary defect classification is accompanied by a probability score or confidence level (e.g., the item is predicted to be defective with an 80% confidence level).

The inspection result may be generated by a system of the present disclosure based at least partially on a predetermined classification algorithm. In some examples, the predetermined classification algorithm specifics respective inspection results for each of the following conditions: (a) both the first defect classification and the second defect classification indicate that the inspected item has no defects, (b) both the first defect classification and the second defect classification indicate that the inspected item has a defect, (c) the first defect classification indicates that the inspected item has no defects and the second defect classification indicates that the inspected item has a defect, and (d) the first defect classification indicates that the inspected item has a defect and the second defect classification indicates that the inspected item has no defects. In some examples, the predetermined classification algorithm is represented as or implemented using a confusion matrix.

In some examples, the inspection result includes the final output or conclusion derived from automatically analyzing the data collected during the inspection of an item or processed data derived therefrom. In some examples, the inspection result provides a single output with respect to a multi-modal defect inspection process. A user may be enabled to adjust the inspection result or to provide feedback to facilitate error resolution.

The inspection result can be presented at a user device in association with an item identifier of the inspected item. The inspection result may be presented in various formats, such as a binary indication of pass/fail, a detailed report listing specific defects, or a graphical representation, such as a confusion matrix that shows the particular defect classification as well as the correlation between different types of potential defect classifications.

In some examples, the structural imaging data includes first structural imaging data and second structural imaging data. The first structural imaging data is generated by the structural imaging sensor and the second structural imaging data include a transformed or processed version of the first structural imaging data. For example, the first structural imaging data provides signal amplitude data reflecting structural characteristics of the inspected item as a time-domain signal, and the first structural imaging data is then automatically processed to transform the time-domain signal to a frequency-domain signal, obtaining the second structural imaging data. In some examples, only the second structural imaging data (and thus not the first structural imaging data) is processed via the second machine learning model, and the second machine learning model can thus be specifically trained for processing a data structure or format corresponding to that of the second structural imaging data.

Examples in the present disclosure utilize one or more item-specific machine learning models. An “item-specific machine learning model,” as used herein, may include a machine learning model that is trained, adjusted, or fine-tuned to recognize or predict outcomes based on data describing a specific type of item. The specific type of item might, for example, be a specific product that a user wishes to have inspected (e.g., a specific electronic device) or a specific part thereof (e.g., a housing of the electronic device or a printed circuit board (PCB) of the electronic device). For example, in a manufacturing setting where different types of products are inspected, an item-specific machine learning model might be developed for each of a number of product or item types. An item-specific machine learning model can be trained on training data that is relevant to its respective product or item type, enabling it to more accurately identify defects that are typical of that product or item.

In some examples, the method includes identifying an item type of the inspected item (e.g., using its item identifier), and automatically selecting, based on the item type, a particular machine learning model from a plurality of item-specific machine learning models. This allows the system to automatically apply a machine learning model that has been trained to detect defects for a specific type of product.

Examples in the present disclosure extend to a system that includes the at least one optical sensor and the at least one structural imaging sensor. The system can be configured to perform operations such as using the optical sensor to capture the one or more images, and using the structural imaging sensor to obtain the structural imaging data. The system can further be configured to perform operations such as transmitting data captured by the optical sensor or the structural imaging sensor to a server for processing (e.g., to generate an inspection result).

Techniques described herein improve the functioning of a computing system, such as an automated defect inspection system, by combining inspection modalities (e.g., combining strengths of RGB cameras and UWB radar), thereby enhancing accuracy and reliability. Examples described in the present disclosure can be applied to different items (e.g., different types of products or parts) and in various operating scenarios (e.g., varying lighting conditions), providing a versatile tool for manufacturing, assembly, or quality control applications.

As mentioned, defect inspection systems that rely solely on optical sensors, such as RGB cameras, can be limited by various factors, such lighting conditions, occlusions, and a limited field of view. Examples described herein address or alleviate these challenges by adding an additional sensing modality that provides structural imaging data. This not only enables the system to detect exterior defects with enhanced accuracy, but also to detect defects that may be “invisible” to optical sensors.

In some examples, data storage requirements as well as transmission costs associated with structural imaging data (such as UWB radar outputs) are more modest than those associated with high-quality RGB images. In some examples, with the support of the additional sensing modality, it may become more feasible or effective to utilize lower quality images, thereby lowering the overall data storage requirements or associated costs for the defect inspection system. Integrations described herein may thus allow a computer system to save or allocate computing resources more efficiently. Examples of such computing resources may include processor cycles, network traffic, memory usage, graphics processing unit (GPU) resources, data storage capacity, power consumption, and cooling capacity.

Examples described in the present disclosure provide a practical application that integrates multiple defect inspection modalities to provide for comprehensive defect detection across a variety of item types or conditions. Examples described herein also provide efficient techniques for generating an inspection result based on multiple inputs, and for resolving conflicting inputs or potential detection errors. The complexity and volume of data involved in one or more of capturing data of an inspected item, processing the data, analyzing data from different modalities, generating accurate and rapid predictions therefrom, and triggering error resolution procedures, necessitate computing system operations since these tasks are not feasible for manual execution by humans.

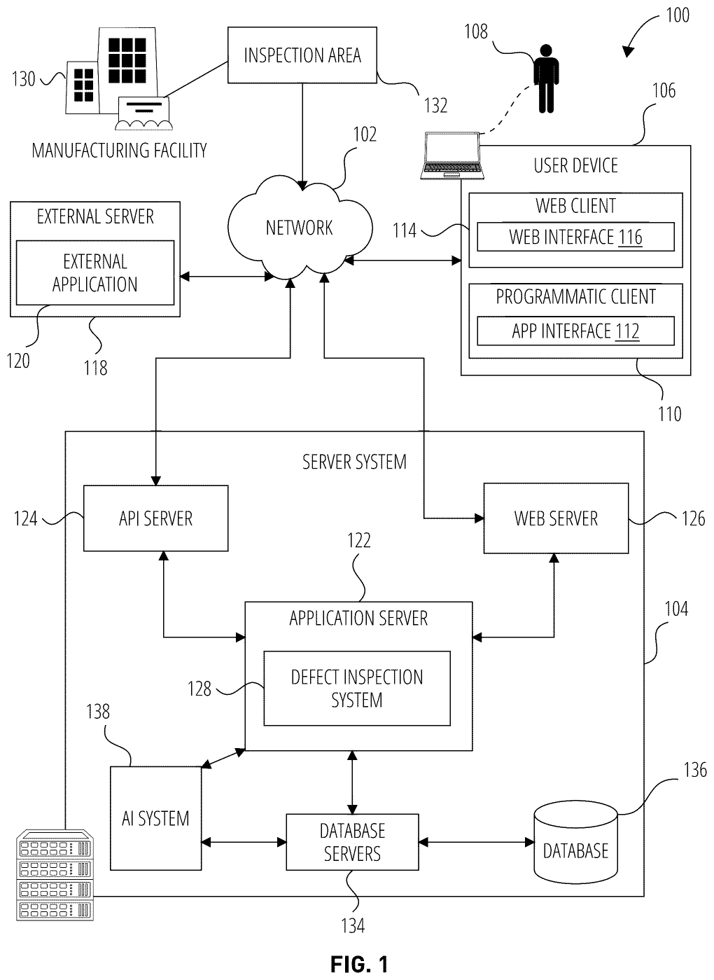

FIG. 1 is a diagrammatic representation of a networked computing environment 100 in which some examples of the present disclosure may be implemented or deployed. One or more servers in a server system 104 provide server-side functionality via a network 102 to a networked device, in the example form of a user device 106 that is accessed by a user 108. A web client 114 (e.g., a browser) or a programmatic client 110 (e.g., an “app”) may be hosted and executed on the user device 106.

An Application Program Interface (API) server 124 and a web server 126 provide respective programmatic and web interfaces to components of the server system 104. A specific application server 122 hosts a defect inspection system 128, which includes components, modules, or applications. The defect inspection system 128 receives, via the network 102, data from a manufacturing facility 130, such as from sensors or other devices in an inspection area 132 of the manufacturing facility 130, to enable the defect inspection system 128 to carry out defect inspection and detection processes.

The user device 106 can communicate with the application server 122, such as via the web interface supported by the web server 126 or via the programmatic interface provided by the API server 124. It will be appreciated that, although only a single user device 106 is shown in FIG. 1, a plurality of user devices may be communicatively coupled to the server system 104 in some examples. Further, while certain functions may be described herein as being performed at either the user device 106 (e.g., web client 114 or programmatic client 110) or the server system 104, the location of certain functionality either within the user device 106 or the server system 104 may be a design choice.

One or more computing devices at the manufacturing facility 130 can also communicate with the application server 122, such as via the programmatic interface provided by the API server 124. It will be appreciated that, although only a single manufacturing facility 130 is shown in FIG. 1, a plurality of facilities may be communicatively coupled to the server system 104 in some examples. Further, while certain functions may be described herein as being performed at either the inspection area 132 or the server system 104, the location of certain functionality either within the inspection area 132 (e.g., at local sensors or controllers) or the server system 104 may be a design choice.

The application server 122 is communicatively coupled to database servers 134, facilitating access to one or more information storage repository, such as a database 136. In some examples, the database 136 includes storage devices that store information to be processed by the defect inspection system 128, such as data records received from the manufacturing facility 130. For instance, the database 136 can store, for each of a number of inspected items that passed through the inspection area 132, one or more images captured by a camera and structural imaging data obtained using a structural imaging sensor. Such data can then be retrieved and processed by the defect inspection system 128.

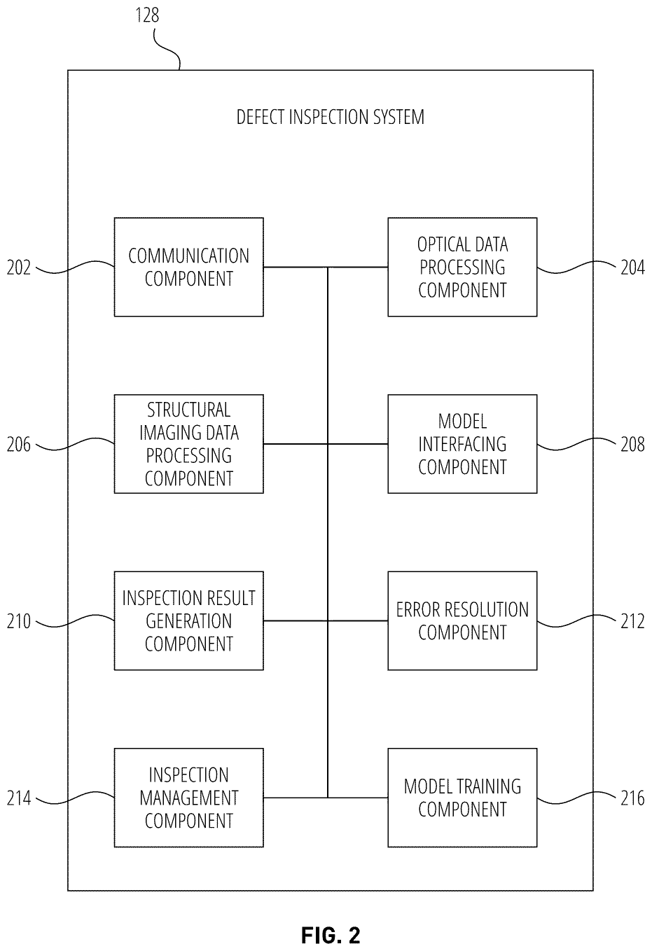

The application server 122 accesses application data to provide one or more applications or software tools to the user device 106 via a web interface 116 or an app interface 112. As described further below according to examples and with specific reference to FIGS. 2-5, the application server 122, using the defect inspection system 128, may provide one or more tools or functions for tracking, managing, or controlling defect inspections related to items inspected in the inspection area 132.

In some examples, the defect inspection system 128 is communicatively coupled to various manufacturing facilities (or other related facilities, such as assembly facilities or quality control facilities) to provide digital manufacturing tools or services. At the facility level, various sensors or devices can collect data as part of a production process. These sensors or devices can be connected to local controllers, which may perform initial data processing and aggregation (at least in some examples). Data is then transmitted to the server system 104 (e.g., using the connections described above), allowing for one or more functions to be performed, such as defect inspection, analytics, reporting, or integration with other processes. For instance, the database 136 remotely stores multi-modal input data collected by local sensors in respective logical buckets within the database 136, and the defect inspection system 128 applies machine learning algorithms to analyze the data, and further uses the results to determine which actions to perform or trigger. The defect inspection system 128 may provide one or more dashboards via a graphical user interface (GUI) on the user device 106, such as a dashboard that summarizes inspection results or allows the user 108 to provide feedback or exercise control over certain aspects of such inspections.

In some examples, the defect inspection system 128 operates together with an artificial intelligence (AI) system 138 of the server system 104. The AI system 138 can provide machine learning models used for generating predictions within automated processes (e.g., to generate a prediction as to whether an inspected item is “defective” or “non-defective”). The AI system 138 may provide various capabilities, such as training models, deploying predictions, and monitoring performance. The AI system 138 may leverage training data sets (e.g., stored in the database 136) to construct machine learning pipelines and train or re-train (e.g., adjust) machine learning models used by the defect inspection system 128.

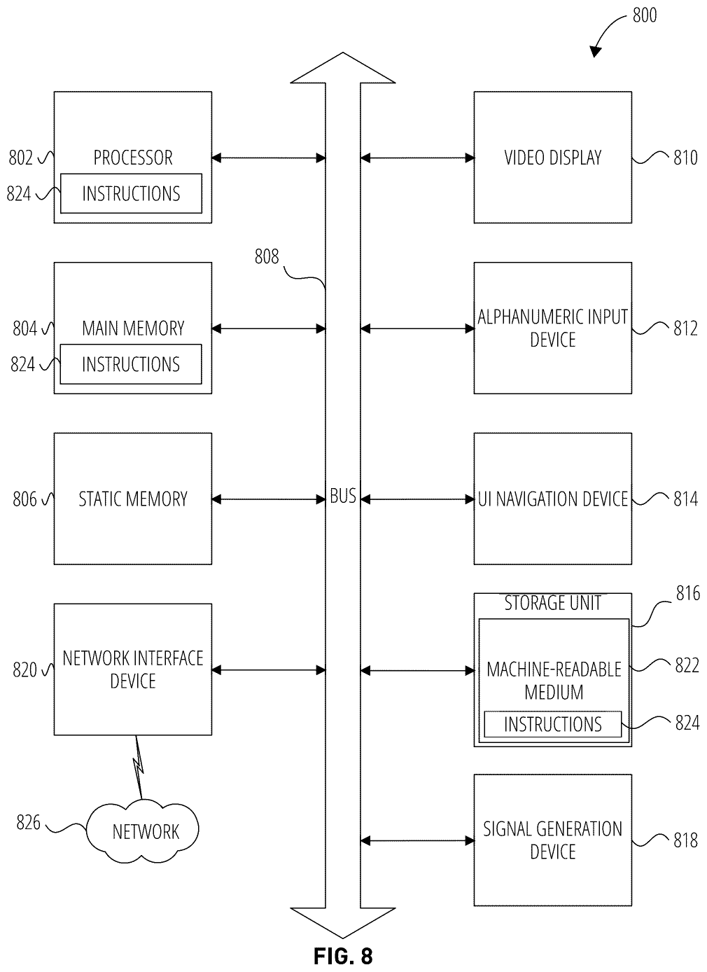

In some examples, the application server 122 is part of a cloud-based platform that allows the user 108 to utilize the tools of the defect inspection system 128 and, optionally, other tools provided by a software service provider. For example, the user 108 is associated with a user account that has access to one or more of these tools via the application server 122. One or more of the application server 122, the database servers 134, the API server 124, the web server 126, and the defect inspection system 128 may each be implemented in a computer system, in whole or in part, as described below with respect to FIG. 8.

In some examples, external applications (which may be third-party applications or applications provided by the service provider that provides the defect inspection system 128), such as an external application 120 executing on an external server 118, can communicate with the application server 122 via the programmatic interface provided by the API server 124. For example, a third-party application may support one or more features or functions on a website or platform hosted by a third party, or may perform certain methodologies and provide input or output information to the application server 122 for further processing or publication.

The network 102 may be any network (or multiple networks) that enables communication between or among machines, databases, and devices. Accordingly, the network 102 may be a wired network, a wireless network (e.g., a mobile or cellular network), or any suitable combination thereof. The network 102 may include one or more portions that constitute a private network, a public network (e.g., the Internet), or any suitable combination thereof.

FIG. 2 is a block diagram illustrating components of the defect inspection system 128 of FIG. 1, according to some examples. In FIG. 2, the defect inspection system 128 is shown to include a communication component 202, an optical data processing component 204, a structural imaging data processing component 206, a model interfacing component 208, an inspection result generation component 210, an error resolution component 212, an inspection management component 214, and a model training component 216.

The communication component 202 receives data sent to the defect inspection system 128 and transmits data from the defect inspection system 128. For example, the communication component 202 receives image data and structural imaging data to allow the defect inspection system 128 to generate defect classifications and inspection results and causes outputs to be communicated to other components or devices (e.g., the user device 106).

The communication component 202 may ensure that data received from sensors is accurately relayed to the appropriate components within the defect inspection system 128. In some examples, the communication component 202 is responsible for managing the flow of data between internal components of the defect inspection system 128 (e.g., between the optical data processing component 204 and the model interfacing component 208). The communication component 202 may provide a graphical user interface of the defect inspection system 128 at the user device 106. This may enable tracking of inspection results as well as real-time or near real-time decision-making or feedback based on inspection outcomes.

The optical data processing component 204 processes image data originating from one or more optical sensors, such as RGB cameras. For example, in the inspection area 132 of the manufacturing facility 130 of FIG. 1, an RGB camera can capture images of products to simulate human vision, with such images serving as inputs to the optical data processing component 204.

The optical data processing component 204 applies computer vision techniques, such as image processing algorithms or machine learning models to analyze the captured images for potential defects. In some examples, optical data processing component 204 can enhance images, extract features, perform segmentation, or detect objects. The optical data processing component 204 can also pre-process images prior to checking for defects (e.g., by adjusting colors, formats, or other image features).

In some examples, the optical data processing component 204 generates, for a given input image, a binary defect classification that indicates whether an item in the image is predicted to be “defective” or “non-defective.” The optical data processing component 204 can work with the AI system 138 of FIG. 1, for example, to utilize trained machine learning models executed by the AI system 138. For example, the optical data processing component 204 communicates with the model interfacing component 208, which in turn instructs the AI system 138 to perform one or more inference tasks and returns the result to the defect inspection system 128.

Various machine learning techniques can be implemented by the optical data processing component 204, including, for example, Convolutional Neural Network (CNN) based deep learning models and/or Recurrent Neural Network (RNN) based deep learning models. The optical data processing component 204 can execute (or cause execution of), for example, a CNN that is trained to identify product defects (or to predict that there are no defects) from input images. The machine learning model can be based on, for instance, a You Only Look Once (YOLO) architecture or similar architecture for object detection. In some examples, the optical data processing component 204 utilizes a Large Vision Model (LVM) such as CLIP (Contrastive Language-Image Pretraining) developed by OpenAI™ or Vision Transformer (ViT) developed by Google™.

In some examples, the optical data processing component 204 utilizes an item-specific machine learning model (e.g., a model that is trained to perform detection on input images depicting products of a specific type). Accordingly, examples in the present disclosure can include training a machine learning model to perform binary defect classifications on respective input images that depict a particular item or type of item. In other examples, the optical data processing component 204 utilizes a more generalized machine learning model that can predict defects across different types of products.

The structural imaging data processing component 206 is responsible for processing a different modality than the optical data processing component 204. The structural imaging data processing component 206 receives structural imaging data, such as UWB radar outputs that provide data describing structural characteristics of an inspected item. For example, in the inspection area 132 of the manufacturing facility 130 of FIG. 1, a radar apparatus can capture data that provides details of the structure or configuration of an item, with such data serving as inputs to the structural imaging data processing component 206.

In some examples, the structural imaging data processing component 206 generates, for a given input item that provides structural imaging data, a binary defect classification that indicates whether an item described by the structural imaging data is predicted to be “defective” or “non-defective.” The structural imaging data processing component 206 can work with the AI system 138 of FIG. 1, for example, to utilize trained machine learning models executed by the AI system 138. For example, the structural imaging data processing component 206 communicates with the model interfacing component 208, which in turn instructs the AI system 138 to perform one or more inference tasks and returns the result to the defect inspection system 128.

Various machine learning techniques can be implemented by the structural imaging data processing component 206, including, for example, CNN-based deep learning models and/or RNN-based deep learning models. The structural imaging data processing component 206 can execute (or cause execution of), for example, a CNN or a RNN that is trained to identify product defects (or to predict that there are no defects) from structural imaging data. A specific (but non-limiting) example of a CNN that can be employed is the ResNet (Residual Neural Network) deep learning architecture. ResNet may, for instance, be effective where the structural imaging data is in the frequency domain since this represents image-like input. Where the structural imaging data is in the time domain it may be useful to employ another model, such as a transformer. Other models, such as Support Vector Machines (SVMs), can also be used in certain examples.

In some examples, the structural imaging data processing component 206 utilizes an item-specific machine learning model (e.g., a model that is trained to perform detection on input data describing the structure of a specific product). Accordingly, examples in the present disclosure can include training a machine learning model to perform binary defect classifications on respective inputs that describe structural features of a particular item or type of item.

Structural imaging data may include data that provides information about the structure, arrangement, or configuration of an inspected item, including internal or hidden aspects of the inspected item. The structural imaging data may be represented in various forms such as signal amplitude graphs, time-domain signals, or frequency-domain signals. For instance, in a manufacturing context, structural imaging data obtained from a UWB radar might include signal amplitude data that reflects the internal integrity of a metallic component. In some examples, the structural imaging data processing component 206 performs pre-processing to transform the “raw” sensor data into a format that is suitable for machine learning model processing. For instance, a raw time-domain signal is automatically converted to a frequency-domain signal in cases where a machine learning model was trained to identify, based on frequency-domain data, whether a particular input is indicative of a product defect.

In some examples, to extract useful information from the structural imaging data (e.g., the radar signal graph), the task can be structured as a pattern recognition task to be performed by the structural imaging data processing component 206. For a certain product (e.g., a particular part that is manufactured in the manufacturing facility 130), the structural imaging data will be identical or nearly identical for all non-defective products. However, if a defect, such as a hole or a scratch, is present, the change in shape will affect the propagation of the signal and this will be reflected in the structural imaging data. Accordingly, a model can be utilized to recognize a particular pattern as corresponding to a non-defective item, thereby also enabling it to identify a defective item accordingly due to a deviation from the pattern. As alluded to above, it may be effective, in some cases, to perform this task on frequency domain data as opposed to time domain data. Thus, a Fourier transform or wavelet transform can be applied to convert time domain signals into frequency domain data.

As mentioned, the model interfacing component 208 in the defect inspection system 128 can be included to coordinate the interaction between various machine learning models and components of the defect inspection system 128. In some examples, the model interfacing component 208 automatically selects a suitable machine learning model (e.g., corresponding to a product type of an inspected item) to use for inference. The model interfacing component 208 can interface with the AI system 138 or with externally hosted systems, such as a third-party system that hosts an LVM, a Large Language Model (LLM), or other model.

The inspection result generation component 210 is responsible for compiling and finalizing inspection outcomes based on analyzed data from the optical data processing component 204 and the structural imaging data processing component 206. In some examples, the inspection result generation component 210 synthesizes classifications provided by the optical data processing component 204 and the structural imaging data processing component 206 to generate a final inspection result. In some examples, inspection result generation component 210 utilizes a predetermined classification algorithm (e.g., as represented by a confusion matrix) to integrate and interpret the findings from the different modalities, providing a condition-based inspection result. In some examples, the inspection result generation component 210 cooperates with the communication component 202 to format the results for presentation, ensuring that they are understandable and useful for decision-making processes, such as quality control assessments.

In some examples, the error resolution component 212 operates to address errors, discrepancies, or anomalies detected during an inspection process. For example, when the inspection result generation component 210 identifies a potential error, such as conflicting defect classifications from the optical and structural imaging analyses, the error resolution component 212 is activated. In some examples, the error resolution component 212 initiates additional inspection procedures or requests human intervention for manual review and verification. The error resolution component 212 may also collect feedback from these interventions to adjust and improve the inspection algorithms (e.g., one of the machine learning models used to generate defect classifications), enhancing the accuracy and reliability of the defect inspection system 128 over time.

The inspection management component 214 may manage an overall inspection workflow to ensure that all sub-tasks are completed to arrive at a final inspection result. For example, the inspection management component 214 schedules or coordinates activities of the optical data processing component 204, the structural imaging data processing component 206, and the inspection result generation component 210, manages data flow within the defect inspection system 128, and oversees the execution of automated inspection protocols.

In some examples, the model training component 216 is responsible for developing or refining the machine learning models used in the defect classification process. For example, the model training component 216 uses historical data and ongoing feedback on the inspection results (e.g., both actual inspection results and user feedback thereon) to train and update the models that drive the optical or structural imaging data analyses. For example, the error resolution component 212 detects a conflict between outputs for different modalities, the user 108 can provide clarifying input, and such input can be used as additional training data to fine-tune one or more of the machine learning models. In some examples, the model training component 216 is implemented as part of, or in cooperation with, the AI system 138.

In some examples, at least some of the components shown in FIG. 2 are configured to communicate with each other to implement aspects described herein. One or more of the components described herein may be implemented using hardware (e.g., one or more processors of one or more machines) or a combination of hardware and software. For example, a component described herein may be implemented by a processor configured to perform the operations described herein for that component. Moreover, two or more of these components may be combined into a single component, or the functions described herein for a single component may be subdivided among multiple components. Furthermore, according to various examples, components described herein may be implemented using a single machine, database, or device, or be distributed across multiple machines, databases, or devices.

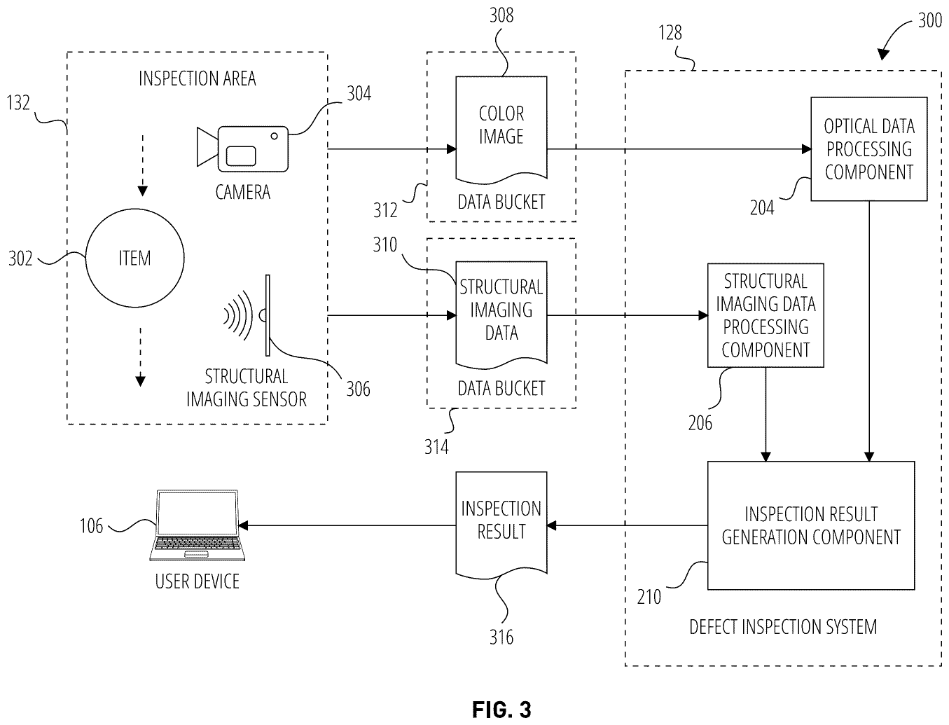

FIG. 3 is a diagram illustrating inspection components in the inspection area 132 of FIG. 1, and further illustrating aspects of a process 300 to generate an inspection result 316, according to some examples. In FIG. 3, the inspection area 132 is shown to include a camera 304 and a structural imaging sensor 306 that both obtain data related to an item 302. For example, the camera 304 is an RGB camera that captures images of items to be inspected, including the item 302 shown in FIG. 3, while the structural imaging sensor 306 is a UWB radar apparatus that obtains structural imaging data of the items to be inspected.

Various types of items can benefit from multi-modal defect detection. For example, the item 302 is a valve head that includes a PCB, wires, and a metal base. The item 302 is sent for a quality check in the inspection area 132 to identify, for example, small holes, abrasions or other non-conformities that could make the item 302 defective (e.g., according to a predetermined standard). The item 302 is thus captured or scanned using the camera 304 and the structural imaging sensor 306 as part of the process 300. In some examples, respective items being captured by the camera 304 are to be positioned (e.g., placed or fixed) in the same pose (e.g., position and orientation) to ensure that they are captured from the same angle. Similarly, respective items being scanned using the structural imaging sensor 306 are to be positioned (e.g., placed or fixed) in the same pose (e.g., position and orientation) to ensure that structural imaging results are effectively comparable.

In some examples, and as shown in FIG. 3, the camera 304 captures a color image 308 of the item 302 from a specific, fixed angle, and a transmitting device in the inspection area 132 transmits the color image 308 to the server system 104 of FIG. 1, where it is stored in a vision modality-specific data bucket 312 (e.g., within or associated with the database 136). The structural imaging sensor 306 obtains structural imaging data, which is also transmitted to the server system 104 and stored in a structural imaging modality-specific data bucket 314 (e.g., within or associated with the database 136). In some examples, the color image 308 is stored in association with an item identifier (e.g., a serial number) of the item 302, and the structural imaging data 310 is stored in association with the same item identifier.

The use of UWB radar in the structural imaging sensor 306 can provide technical benefits. UWB radar operates by transmitting and receiving short duration pulses of radio frequency energy. Signals reflected by a target can be represented, for example, as a graph that shows the amplitude of the signal over time or distance. One specific approach is to represent time on the x-axis of a graph and strength or amplitude of the signal on the y-axis of the graph.

UWB technology operates over a wide frequency range from 3.1 gigahertz (GHz) to 10.6 GHz, and the transmitting bandwidth is typically greater than 500 megahertz (MHZ). Its wide bandwidth provides strong penetration capabilities, allowing UWB technology to locate both line of sight (LOS) and non-line of sight (NLOS) defects. For example, whereas the camera 304 may be unable to capture a defect that is covered or occluded by another part, or located on the interior of the item 302, the defect can be uncovered using UWB technology.

Furthermore, due to its narrow pulse width, UWB technology can typically obtain precise location information (e.g., centimeter-level precision). This enables, for example, the structural imaging sensor 306 to be used to identify an item as defective even if a defect is relatively small. Moreover, UWB radar provides for relatively low power consumption. UWB technology can thus effectively and efficiently supplement a vision modality.

Accordingly, in some examples, the color image 308 provides a visual illustration of the item 302 (e.g., in RGB format), while the structural imaging data 310 provides a structural imaging result. As further shown in FIG. 3, the defect inspection system 128 receives the color image 308 and processes the color image 308 via the optical data processing component 204. The processing of the color image 308 provides a first defect classification. The optical data processing component 204 uses, for example, a pre-trained general defect inspection binary classification model for RGB images (e.g., trained on labeled training data comprising images of various defective and non-defective products). In some examples, the model's weights are iteratively updated based on user feedback to achieve better domain generalization ability and higher accuracy.

The defect inspection system 128 also receives the structural imaging data 310 and processes the structural imaging data 310 via the structural imaging data processing component 206. The processing of the structural imaging data 310 provides a second defect classification. The structural imaging data processing component 206 uses, for example, an item-specific machine learning model that was trained to recognize a certain pattern as “non-defective” for items of the item type of the item 302. In some examples, the model's weights are iteratively updated based on user feedback to achieve higher accuracy.

The structural imaging data 310 can include a graph that can be used to identify object boundaries and layers, depth information, material properties such as density, attenuation, or internal structures. As mentioned, in some examples, the structural imaging data 310 is received at the defect inspection system 128 as time domain data, and converted to frequency domain data prior to defect analysis. This may allow the defect inspection system 128 to decompose a relatively complex signal, which could contain noise information, into sub-signals with different frequencies, allowing for more accurate analysis.

In some examples, one or both of the first defect classification and the second defect classification utilizes a threshold for flagging an item as defective. For example, the user 108 of the user device 106 may select a threshold of 60% for both the first defect classification and the second defect classification. Accordingly, if either the optical data processing component 204 or the structural imaging data processing component 206 processes their respective input and obtains a “defective probability” or “confidence level” of more than 60%, the item 302 is flagged as defective in the respective defect classification.

The threshold applied to a model or its output may be user-adjustable. For example, if the user 108 wishes to obtain higher precision, the user 108 can opt to increase the threshold. This generally improves precision but reduces recall. On the other hand, decreasing the threshold can improve recall but generally reduces precision.

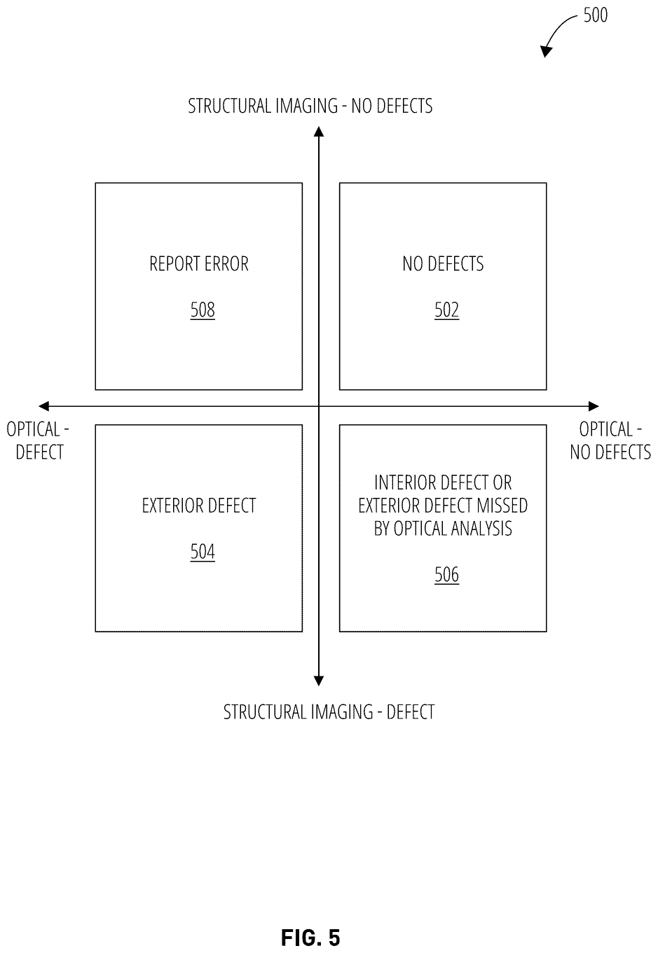

The inspection result generation component 210 uses both the first defect classification and the second defect classification to generate an inspection result 316. In some examples, the inspection result 316 is a binary defect classification that is presented at the user device 106 (e.g., to indicate that the item 302 was found to be defective). A non-limiting example of a classification algorithm that can be applied to generate the inspection result 316 is described with reference to FIG. 5.

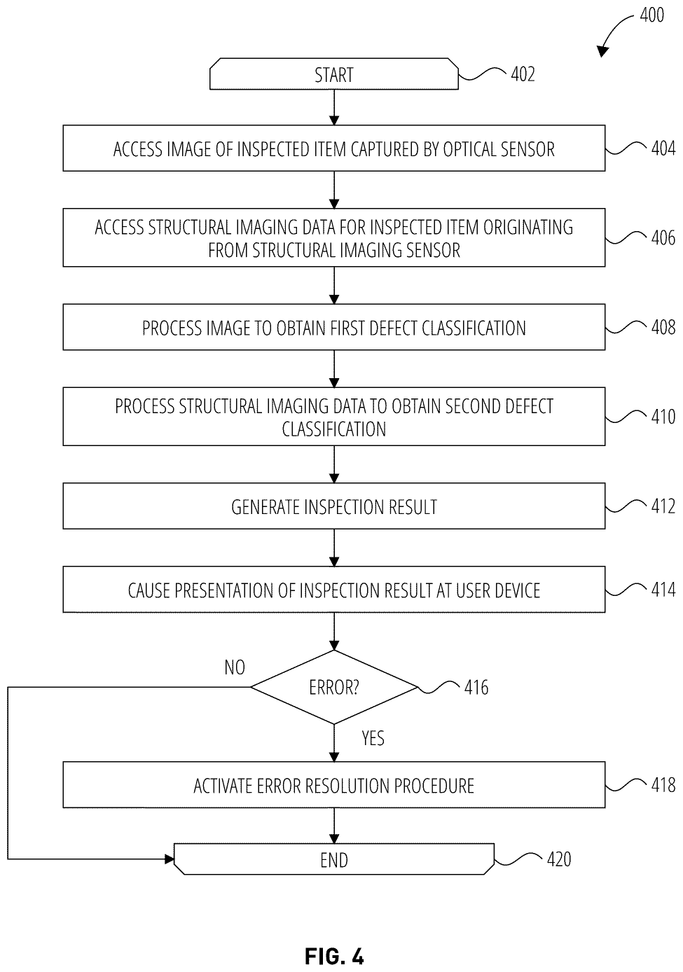

FIG. 4 is a flowchart illustrating operations of a method 400 for multi-modal defect inspection, according to some examples. By way of example and not limitation, aspects of the method 400 may be performed by the components, devices, systems, network, or database shown in FIGS. 1 to 3, and some of them are thus referenced in the description below.

The method 400 commences at opening loop operation 402 and proceeds to operation 404, where the defect inspection system 128 accesses an image of an inspected item that was captured by an optical sensor, such as the camera 304 of FIG. 3. At operation 406, the defect inspection system 128 accesses structural imaging data of the same inspected item that was obtained via a structural imaging sensor, such as the structural imaging sensor 306 of FIG. 3.

In some examples, in response to receiving the sensor data (e.g., image and structural imaging data) for a new inspected item, the defect inspection system 128 automatically assigns an item identifier such as a serial number to the inspected item. In other examples, the item identifier is assigned at the manufacturing facility 130 and provided together with the relevant sensor data.

At operation 408, the optical data processing component 204 processes the image to obtain a first defect classification. For example, the first defect classification flags the inspected item as “defective” or “non-defective.” At operation 410, the structural imaging data is processed by the structural imaging data processing component 206 to obtain a second defect classification for the same inspected item. The second defect classification can be the same as the first defect classification, but may in some cases be different. For example, the first defect classification flags the inspected item as “non-defective” or “conformant,” while the second defect classification flags the same inspected item as “defective.”

The inspection result generation component 210 of the defect inspection system 128 then processes the first defect classification and the second defect classification to arrive at an inspection result for the inspected item (e.g., the item associated with an assigned serial number). The inspection result is generated at operation 412, and is presented at the user device 106 (e.g., via the web interface 116) at operation 414. Where the first defect classification and the second defect classification are the same, the inspection result may mirror this classification. In cases where the classifications differ, the inspection result generation component 210 determines the appropriate inspection result to output according to a predetermined classification algorithm. A non-limiting example of a classification algorithm that can be applied to generate the inspection result is described with reference to FIG. 5.

At decision operation 416, the defect inspection system 128 determines whether the inspection result is associated with an error or a potential error. For example, and as described with reference to FIG. 5, a certain combination of defect classifications (as obtained from the optical data processing component 204 and the structural imaging data processing component 206) can be associated with an erroneous inspection result. Merely as a non-limiting example, if the first defect classification originating from a captured RGB image indicates “defective” and the second defect classification originating from structural imaging data indicates “non-defective,” the defect inspection system 128 associates the inspection result with an error and automatically activates an error resolution procedure at operation 418.

The error resolution procedure can involve automatically generating, by the defect inspection system 128, an instruction to perform an additional inspection. For example, the defect inspection system 128 transmits an instruction to the user device 106 or to a device at the manufacturing facility 130 to “re-run” the item, in which case operations of the method 400 are repeated using a new set of sensor data.

Alternatively, or additionally, the defect inspection system 128 transmits an instruction to the user device 106 or to a device at the manufacturing facility 130 to submit a manual inspection result for the item to enable the defect inspection system 128 to resolve the error. For example, the manual inspection result can indicate that the item is either “conformant” (e.g., non-defective) or “defective.” In some examples, the manual inspection result is applied by the defect inspection system 128 to update the inspection result (e.g., to adjust a stored inspection result in the database 136), and, in some cases, to further train one or more machine learning models, as described elsewhere. The method 400 concludes at closing loop operation 420. If no error is detected at decision operation 416, the method 400 also concludes at closing loop operation 420 (but in the absence of operation 418).

FIG. 5 illustrates a confusion matrix 500, according to some examples. The confusion matrix 500 illustrates the manner in which a defect inspection system, such as the defect inspection system 128 of FIG. 1 or FIG. 2, can generate an inspection result based on two separate inputs: a first defect classification related to input data received from an optical sensor (e.g., an RGB image) and a second defect classification related to input data received from a structural imaging sensor (e.g., a UWB scanner).

In some examples, and as is the case in FIG. 5, the defect inspection system 128 receives machine learning model output from a first machine learning model and a second machine learning model. The first machine learning model provides a first defect classification that relates to a visual inspection performed by an optical sensor (indicated as “optical” in FIG. 5). The second machine learning model provides a second defect classification that relates to structural imaging data obtained by a structural imaging sensor (indicated as “structural imaging” in FIG. 5). There are four possible results when combining the first defect classification and the second defect classification: (a) both the first defect classification and the second defect classification indicate that the inspected item has no defects, (b) both the first defect classification and the second defect classification indicate that the inspected item has a defect, (c) the first defect classification indicates that the inspected item has no defects and the second defect classification indicates that the inspected item has a defect, and (d) the first defect classification indicates that the inspected item has a defect and the second defect classification indicates that the inspected item has no defects. Scenarios (a) to (d) are handled automatically by the defect inspection system 128, according to a predetermined classification algorithm, which is discussed below.

Scenario (a) corresponds to a first inspection result 502 shown in FIG. 5. For example, the defect inspection system 128 detects that both the first machine learning model and the second machine learning model consider (e.g., predict or estimate) the item as non-defective, and returns output to the user device 106 that indicates that no defects were detected (e.g., “No Defect: Good product”).

Scenario (b) corresponds to a second inspection result 504 shown in FIG. 5. For example, the defect inspection system 128 detects that the first defect classification and the second defect classification both indicate that a defect is present. Since the first defect classification relates to an exterior visual inspection that does not involve analysis of the interior of the item, the defect inspection system 128 determines that at least an exterior or surface defect is present. In other words, there is, for example, a defect on the surface of the product and potentially other defects that are not visible to the optical sensor but detectable via the structural imaging sensor. Thus, a method according to some examples, as performed by the defect inspection system 128, can include detecting that both the first defect classification and the second defect classification indicate that the inspected item has a defect, and, in response thereto, generating the inspection result so as to indicate that the inspected item has one or more defects that include at least one exterior defect.

Scenario (c) corresponds to a third inspection result 506 shown in FIG. 5. For example, the defect inspection system 128 detects that the first defect classification indicates “no defect” and the second defect classification indicates “defect.” Based on this information, the defect inspection system 128 determines that the item has an interior defect or an exterior defect, the latter not having been picked up via the optical sensor data. There could, for instance, be no defect on the particular surface or surfaces of a product captured by the camera 304 from its viewing angle, but rather on a surface that is not visible to the camera 304 (e.g., outside of its field of view). Alternatively, or additionally, the quality of the image may be poor (e.g., captured in conditions that are too dark, too blurry, or too few pixels), resulting in the first defect classification falsely indicating “no defect.” Thus, a method according to some examples, as performed by the defect inspection system 128, can include detecting that the first defect classification indicates that the inspected item has no defects and the second defect classification indicates that the inspected item has a defect, and, in response thereto, generating the inspection result so as to indicate that the inspected item has a defect. This defect may include at least one of an interior defect or an exterior defect that was not detected from the one or more images.

Scenario (d) corresponds to a fourth inspection result 508 shown in FIG. 5. In this case, when the first defect classification (vision inspection modality) indicates “defect” but the second defect classification (structural imaging inspection modality) indicates “no defect,” the defect inspection system 128 associates the inspection result with an error and may automatically activate an error resolution procedure.

The error resolution procedure may include receiving from the user device 106 of FIG. 1 and at the defect inspection system 128, feedback regarding the error, and automatically adjusting the inspection result based on the feedback. For example, the defect inspection system 128 can automatically prompt the user 108 to perform a manual check and to record the correct classification for storing in the database 136 or for model retraining or fine-tuning. Other examples of error resolution are described elsewhere.

Thus, in some examples, the method performed by the defect inspection system 128 includes detecting that the first defect classification indicates that the inspected item has a defect and the second defect classification indicates that the inspected item has no defects, and in response thereto, generating the inspection result to indicate an error and/or automatically activating an error resolution procedure that comprises triggering an additional inspection of the inspected item.

A confusion matrix, such as the confusion matrix 500 of FIG. 5, can be generated and presented at the user device 106 (e.g., via the web interface 116 of FIG. 1). In this way, the user 108 is presented with output in a user-friendly manner. In the context of defect detection using binary defect classification, a confusion matrix or other similar graphical representation can aid in understanding how the defect inspection system 128 is operating to distinguish between defective and non-defective items.

In some examples, the confusion matrix 500 or other graphical representation of the result is presented with the relevant result highlighted or marked, and together with an item identifier of the relevant inspected item. In some examples, the inspection result is presented together with one or more confidence levels or probabilities. For example, the defect inspection system 128 can cause presentation of the probability scores generated by each respective model that led to the flagging of an item as “defective” or “non-defective.”

In some examples, the user 108 is enabled to provide input, such as confirming or adjusting the inspection result. For example, the user 108 is presented with the confusion matrix 500 that has the first inspection result 502 marked for a particular item, and provides user input to confirm that there are indeed “no defects.” This concludes the inspection process and causes the defect inspection system 128 to store the final inspection result in the database 136.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one memory that stores instructions; and one or more processors configured by the instructions to perform operations comprising: accessing one or more images of an inspected item and structural imaging data of the inspected item, the one or more images captured by at least one optical sensor and the structural imaging data obtained via at least one structural imaging sensor; processing the one or more images via a first machine learning model to obtain a first defect classification; processing at least some of the structural imaging data via a second machine learning model to obtain a second defect classification; automatically generating, based on the first defect classification and the second defect classification, an inspection result; and causing presentation, at a user device, of the inspection result in association with an item identifier of the inspected item.

In Example 2, the subject matter of Example 1 includes, wherein generating the inspection result comprises: detecting that both the first defect classification and the second defect classification indicate that the inspected item has a defect; and in response to detecting that both the first defect classification and the second defect classification indicate that the inspected item has a defect, generating the inspection result so as to indicate that the inspected item has one or more defects that include at least one exterior defect.

In Example 3, the subject matter of any of Examples 1-2 includes, wherein generating the inspection result comprises: detecting that the first defect classification indicates that the inspected item has no defects and the second defect classification indicates that the inspected item has a defect; in response to detecting that the first defect classification indicates that the inspected item has no defects and the second defect classification indicates that the inspected item has a defect, generating the inspection result so as to indicate that the inspected item has at least one of an interior defect or an exterior defect that was not detected from the one or more images.

In Example 4, the subject matter of any of Examples 1-3 includes, wherein generating the inspection result comprises: detecting that the first defect classification indicates that the inspected item has a defect and the second defect classification indicates that the inspected item has no defects; and in response to detecting that the first defect classification indicates that the inspected item has a defect and the second defect classification indicates that the inspected item has no defects: generating the inspection result to indicate an error; and automatically activating an error resolution procedure that comprises triggering an additional inspection of the inspected item.

In Example 5, the subject matter of Example 4 includes, wherein the error resolution procedure further comprises: receiving, from the user device, feedback regarding the error; automatically adjusting the inspection result based on the feedback.

In Example 6, the subject matter of Example 5 includes, the operations further comprising: adjusting at least one of the first machine learning model or the second machine learning model based at least partially on the feedback.

In Example 7, the subject matter of any of Examples 1-6 includes, wherein the inspection result is generated based on a predetermined classification algorithm that specifies respective inspection results for each of the following conditions: both the first defect classification and the second defect classification indicate that the inspected item has no defects, both the first defect classification and the second defect classification indicate that the inspected item has a defect, the first defect classification indicates that the inspected item has no defects and the second defect classification indicates that the inspected item has a defect, and the first defect classification indicates that the inspected item has a defect and the second defect classification indicates that the inspected item has no defects.

In Example 8, the subject matter of any of Examples 1-7 includes, wherein the first defect classification and the second defect classification are binary defect classifications, and the operations further comprise at least one of: training the first machine learning model to perform binary defect classifications on respective input images; or training the second machine learning model to perform binary defect classifications on respective structural imaging data.

In Example 9, the subject matter of any of Examples 1-8 includes, wherein the structural imaging data comprises first structural imaging data and second structural imaging data, the first structural imaging data being generated by the at least one structural imaging sensor to provide signal amplitude data as a time-domain signal, the operations further comprising: processing the first structural imaging data to transform the time-domain signal to a frequency-domain signal, thereby obtaining the second structural imaging data, wherein the second structural imaging data is processed via the second machine learning model.

In Example 10, the subject matter of any of Examples 1-9 includes, wherein the second machine learning model is one of a plurality of item-specific second machine learning models, each of the plurality of item-specific second machine learning models being trained to detect defects in a respective type of item, the operations further comprising: identifying an item type of the inspected item; and automatically selecting, based on the item type, the second machine learning model from the plurality of item-specific second machine learning models.

In Example 11, the subject matter of any of Examples 1-10 includes, wherein the at least one structural imaging sensor comprises a radar apparatus.

In Example 12, the subject matter of Example 11 includes, wherein the radar apparatus comprises a UWB scanner.

In Example 13, the subject matter of any of Examples 1-12 includes, wherein the at least one optical sensor comprises a color camera.

In Example 14, the subject matter of any of Examples 1-13 includes, wherein the system comprises the at least one optical sensor and the at least one structural imaging sensor, the operations further comprising: using the at least one optical sensor to capture the one or more images; and using the at least one structural imaging sensor to obtain the structural imaging data.

Example 15 is a method comprising: accessing, by at least one processor, one or more images of an inspected item and structural imaging data of the inspected item, the one or more images captured by at least one optical sensor and the structural imaging data obtained via at least one structural imaging sensor; processing, by the at least one processor, the one or more images via a first machine learning model to obtain a first defect classification; processing, by the at least one processor, at least some of the structural imaging data via a second machine learning model to obtain a second defect classification; automatically generating, by the at least one processor and based on the first defect classification and the second defect classification, an inspection result; and causing presentation, by the at least one processor, of the inspection result in association with an item identifier of the inspected item at a user device.

In Example 16, the subject matter of Example 15 includes, wherein generating the inspection result comprises: detecting that the first defect classification indicates that the inspected item has a defect and the second defect classification indicates that the inspected item has no defects; and in response to detecting that the first defect classification indicates that the inspected item has a defect and the second defect classification indicates that the inspected item has no defects: generating the inspection result to indicate an error; and automatically activating an error resolution procedure that comprises triggering an additional inspection of the inspected item.

In Example 17, the subject matter of Example 16 includes, wherein the error resolution procedure further comprises: receiving, from the user device, feedback regarding the error; automatically adjusting, by the at least one processor, the inspection result based on the feedback.

Example 18 is one or more non-transitory computer-readable media storing computer-executable instructions that, when executed by a computing system, cause the computing system to perform operations comprising: accessing one or more images of an inspected item and structural imaging data of the inspected item, the one or more images captured by at least one optical sensor and the structural imaging data obtained via at least one structural imaging sensor; processing the one or more images via a first machine learning model to obtain a first defect classification; processing at least some of the structural imaging data via a second machine learning model to obtain a second defect classification; automatically generating, based on the first defect classification and the second defect classification, an inspection result; and causing presentation, at a user device, of the inspection result in association with an item identifier of the inspected item.

In Example 19, the subject matter of Example 18 includes, wherein generating the inspection result comprises: detecting that the first defect classification indicates that the inspected item has a defect and the second defect classification indicates that the inspected item has no defects; and in response to detecting that the first defect classification indicates that the inspected item has a defect and the second defect classification indicates that the inspected item has no defects: generating the inspection result to indicate an error; and automatically activating an error resolution procedure that comprises triggering an additional inspection of the inspected item.

In Example 20, the subject matter of Example 19 includes, wherein the error resolution procedure further comprises: receiving, from the user device, feedback regarding the error; automatically adjusting the inspection result based on the feedback.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

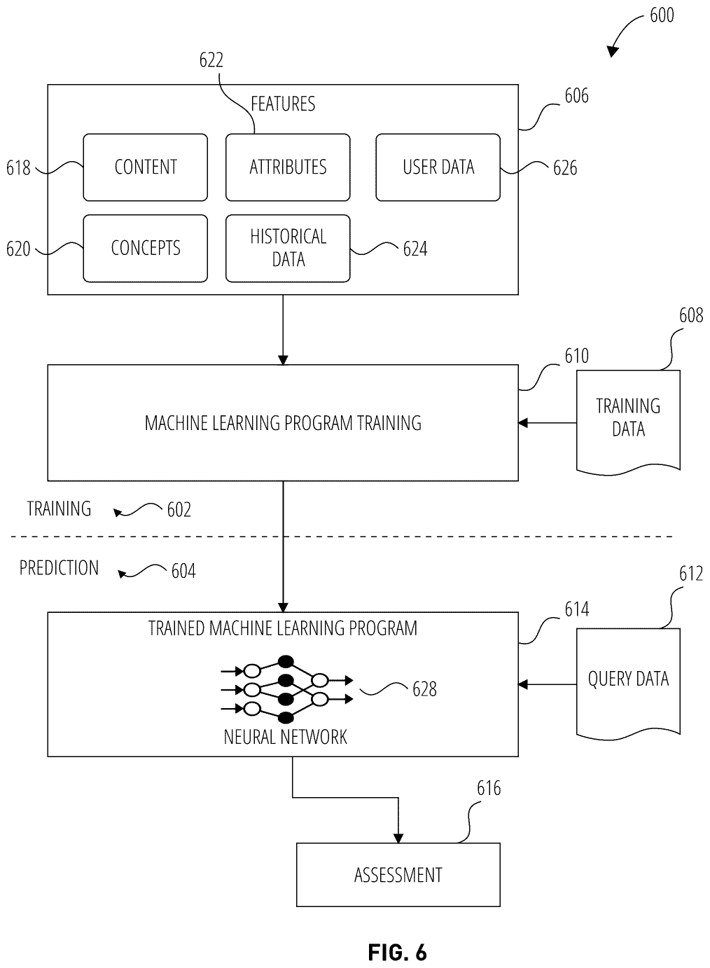

FIG. 6 is a block diagram showing a machine learning program 600, according to some examples. Machine learning programs, also referred to as machine learning algorithms or tools, may be used as part of the systems described herein to perform one or more operations.

Machine learning is a field of study that gives computers the ability to learn without being explicitly programmed. Machine learning explores the study and construction of algorithms, also referred to herein as tools, that may learn from or be trained using existing data and make predictions about or based on new data. Such machine learning tools operate by building a machine learning model from example training data 608 in order to make data-driven predictions or decisions expressed as outputs or assessments (e.g., assessment 616). Although examples are presented with respect to a few machine learning tools, the principles presented herein may be applied to other machine learning tools.

In some examples, different machine learning tools may be used. For example, Logistic Regression (LR), Naive-Bayes, Random Forest (RF), neural networks (NN), matrix factorization, and Support Vector Machines (SVM) tools may be used.

Two common types of problems in machine learning are classification problems and regression problems. Classification problems, also referred to as categorization problems, aim at classifying items into one of several category values (for example, “is this object an apple or an orange?” or “is this item defective or non-defective?”). Regression algorithms aim at quantifying some items (for example, by providing a value that is a real number).

The machine learning program 600 supports two types of phases, namely training phases 602 and prediction phases 604. In training phases 602, supervised learning, unsupervised or reinforcement learning may be used. For example, the machine learning program 600 (1) receives features 606 (e.g., as structured or labeled data in supervised learning) and/or (2) identifies features 606 (e.g., unstructured or unlabeled data for unsupervised learning) in training data 608. In prediction phases 604, the machine learning program 600 uses the features 606 for analyzing query data 612 to generate outcomes or predictions, as examples of an assessment 616.

In the training phase 602, feature engineering is used to identify features 606 and may include identifying informative, discriminating, and independent features for the effective operation of the machine learning program 600 in pattern recognition, classification, and regression. In some examples, the training data 608 includes labeled data, which is known data for pre-identified features 606 and one or more outcomes. Each of the features 606 may be a variable or attribute, such as individual measurable property of a process, article, system, or phenomenon represented by a data set (e.g., the training data 608). Features 606 may also be of different types, such as numeric features, strings, and graphs, and may include one or more of content 618, concepts 620, attributes 622, historical data 624 and/or user data 626, merely for example.

The concept of a feature in this context is related to that of an explanatory variable used in statistical techniques such as linear regression. Choosing informative, discriminating, and independent features is important for the effective operation of the machine learning program 600 in pattern recognition, classification, and regression. Features may be of different types, such as numeric features, strings, and graphs.

In training phases 602, the machine learning program 600 uses the training data 608 to find correlations among the features 606 that affect a predicted outcome or assessment 616. With the training data 608 and the identified features 606, the machine learning program 600 is trained during the training phase 602 at machine learning program training 610. The machine learning program 600 appraises values of the features 606 as they correlate to the training data 608. The result of the training is the trained machine learning program 614 (e.g., a trained or learned model).

Further, the training phases 602 may involve machine learning in which the training data 608 is structured (e.g., labeled during preprocessing operations), and the trained machine learning program 614 implements a relatively simple neural network 628 capable of performing, for example, classification and clustering operations. In other examples, the training phase 602 may involve deep learning, in which the training data 608 is unstructured, and the trained machine learning program 614 implements a deep neural network 628 that is able to perform both feature extraction and classification/clustering operations.

A neural network 628 generated during the training phase 602, and implemented within the trained machine learning program 614, may include a hierarchical (e.g., layered) organization of neurons. For example, neurons (or nodes) may be arranged hierarchically into a number of layers, including an input layer, an output layer, and multiple hidden layers. Each of the layers within the neural network 628 can have one or many neurons and each of these neurons operationally computes a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which defines the influence of the input from a transmitting neuron to a receiving neuron.

In some examples, the neural network 628 may also be one of a number of different types of neural networks, including a single-layer feed-forward network, an Artificial Neural Network (ANN), a RNN, a symmetrically connected neural network, and unsupervised pre-trained network, a transformer network, or a CNN, merely for example.

During prediction phases 604, the trained machine learning program 614 is used to perform an assessment. Query data 612 is provided as an input to the trained machine learning program 614, and the trained machine learning program 614 generates the assessment 616 as output, responsive to receipt of the query data 612.

In some examples, the trained machine learning program 614 may comprise a generative AI model. Generative AI is a term that may refer to AI that can create new content. For example, generative AI can produce text, images, video, audio, code, or synthetic data.

Some of the techniques that may be used in generative AI are:
Generative Adversarial Networks (GANs): GANs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer-based models can handle sequential data, such as text or speech, as well as non-sequential data, such as images or code. For example, a Large Language Model (LLM) may be a transformer model, or may be based on a transformer model. Non-limiting examples of LLMs that use transformer models include GPT-4 (Generative Pre-trained Transformer 4) developed by OpenAI™, BERT (Bidirectional Encoder Representations from Transformers) developed by Google™ LLAMA (Large Language Model Meta AI) developed by Meta™, PaLM2 (Pathways Language Model 2) developed by Google™, and Claude 3 developed by Anthropic™.

In generative AI examples, the assessment 616 generated as a response or output by the trained machine learning program 614 may include predictions, translations, summaries, answers to questions, suggestions, media content, or combinations thereof.

In some examples, a machine learning model may be fine-tuned. The term “fine-tuning,” as used herein, generally refers to a process of adapting a pre-trained or “base” machine learning model. For example, a machine learning model may be adapted to improve its performance on a specific task or to make it more suitable for a specific operation. Fine-tuning techniques may include one or more of updating or changing a pre-trained model's internal parameters through additional training, injecting new trainable weights or layers into the model architecture and training on those weights or layers, modifying a model topology by altering layers or connections, changing aspects of the training process (such as loss functions or optimization methods), or any other adaptations that may, for example, result in better model performance on a particular task compared to the pre-trained model.

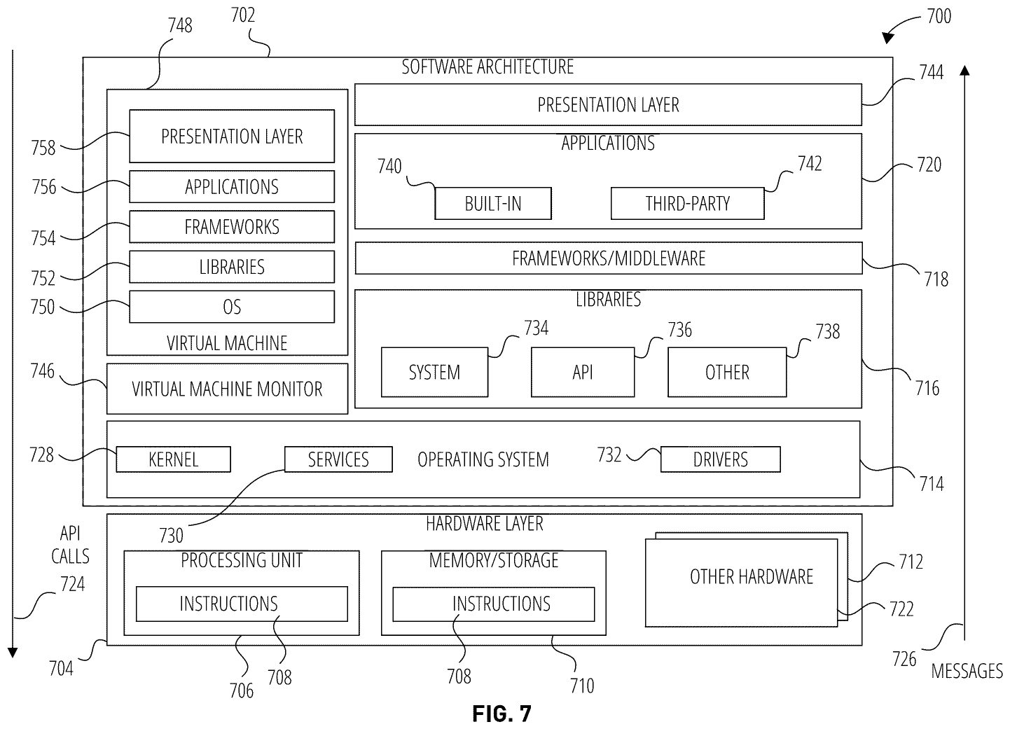

FIG. 7 is a block diagram 700 showing a software architecture 702 for a computing device, according to some examples. The software architecture 702 may be used in conjunction with various hardware architectures, for example, as described herein. FIG. 7 is merely a non-limiting illustration of a software architecture, and many other architectures may be implemented to facilitate the functionality described herein. A representative hardware layer 704 is illustrated and can represent, for example, any of the above referenced computing devices. In some examples, the hardware layer 704 may be implemented according to the architecture of the computer system of FIG. 8.

The representative hardware layer 704 comprises one or more processing units 706 having associated executable instructions 708. Executable instructions 708 represent the executable instructions of the software architecture 702, including implementation of the methods, modules, subsystems, and components, and so forth described herein and may also include memory and/or storage modules 710, which also have executable instructions 708. Hardware layer 704 may also comprise other hardware as indicated by other hardware 712 and other hardware 722 which represent any other hardware of the hardware layer 704, such as the other hardware illustrated as part of the software architecture 702.

In the architecture of FIG. 7, the software architecture 702 may be conceptualized as a stack of layers where each layer provides particular functionality. For example, the software architecture 702 may include layers such as an operating system 714, libraries 716, frameworks/middleware layer 718, applications 720, and presentation layer 744. Operationally, the applications 720 or other components within the layers may invoke API calls 724 through the software stack and access a response, returned values, and so forth illustrated as messages 726 in response to the API calls 724. The layers illustrated are representative in nature and not all software architectures have all layers. For example, some mobile or special purpose operating systems may not provide a frameworks/middleware layer 718, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. In some examples, the services 730 include an interrupt service. The interrupt service may detect the receipt of an interrupt and, in response, cause the software architecture 702 to pause its current processing and execute an interrupt service routine (ISR) when an interrupt is accessed.

The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 716 may provide a common infrastructure that may be utilized by the applications 720 or other components or layers. The libraries 716 typically provide functionality that allows other software modules to perform tasks in an easier fashion than to interface directly with the underlying operating system 714 functionality (e.g., kernel 728, services 730 or drivers 732). The libraries 716 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks/middleware layer 718 may provide a higher-level common infrastructure that may be utilized by the applications 720 or other software components/modules. For example, the frameworks/middleware layer 718 may provide various graphic user interface (GUI) functions, high-level resource management, high-level location services, and so forth. The frameworks/middleware layer 718 may provide a broad spectrum of other APIs that may be utilized by the applications 720 or other software components/modules, some of which may be specific to a particular operating system or platform.

The applications 720 include built-in applications 740 or third-party applications 742. Examples of representative built-in applications 740 may include, but are not limited to, a contacts application, a browser application, a book reader application, a location application, a media application, a messaging application, or a game application. Third-party applications 742 may include any of the built-in applications as well as a broad assortment of other applications. In a specific example, the third-party application 742 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 742 may invoke the API calls 724 provided by the mobile operating system such as operating system 714 to facilitate functionality described herein.

The applications 720 may utilize built in operating system functions (e.g., kernel 728, services 730 or drivers 732), libraries (e.g., system libraries 734, API libraries 736, and other libraries 738), and frameworks/middleware layer 718 to create user interfaces to interact with users of the system. Alternatively, or additionally, in some systems, interactions with a user may occur through a presentation layer, such as presentation layer 744. In these systems, the application/module “logic” can be separated from the aspects of the application/module that interact with a user.

Some software architectures utilize virtual machines. In the example of FIG. 7, this is illustrated by virtual machine 748. A virtual machine creates a software environment where applications/modules can execute as if they were executing on a hardware computing device. A virtual machine is hosted by a host operating system (operating system 714) and typically, although not always, has a virtual machine monitor 746, which manages the operation of the virtual machine as well as the interface with the host operating system (e.g., operating system 714). A software architecture executes within the virtual machine 748 such as an operating system 750, libraries 752, frameworks/middleware 754, applications 756 or presentation layer 758. These layers of software architecture executing within the virtual machine 748 can be the same as corresponding layers previously described or may be different.

Certain examples are described herein as including logic or a number of components, modules, or mechanisms. Modules or components may constitute either software modules/components (e.g., code embodied (1) on a non-transitory machine-readable medium or (2) in a transmission signal) or hardware-implemented modules/components. A hardware-implemented module/component is a tangible unit capable of performing certain operations and may be configured or arranged in a certain manner. In examples, one or more computer systems (e.g., a standalone, client, or server computer system) or one or more hardware processors may be configured by software (e.g., an application or application portion) as a hardware-implemented module/component that operates to perform certain operations as described herein.

In various examples, a hardware-implemented module/component may be implemented mechanically or electronically. For example, a hardware-implemented module/component may comprise dedicated circuitry or logic that is permanently configured (e.g., as a special-purpose processor, such as a field programmable gate array (FPGA) or an application-specific integrated circuit (ASIC)) to perform certain operations. A hardware-implemented module/component may also comprise programmable logic or circuitry (e.g., as encompassed within a general-purpose processor or another programmable processor) that is temporarily configured by software to perform certain operations.

Accordingly, the term “hardware-implemented module” or “hardware-implemented component” should be understood to encompass a tangible entity, be that an entity that is physically constructed, permanently configured (e.g., hardwired), or temporarily or transitorily configured (e.g., programmed) to operate in a certain manner or to perform certain operations described herein. Considering examples in which hardware-implemented modules/components are temporarily configured (e.g., programmed), each of the hardware-implemented modules/components need not be configured or instantiated at any one instance in time. For example, where the hardware-implemented modules/components comprise, a general-purpose processor configured using software, the general-purpose processor may be configured as respective different hardware-implemented modules/components at different times. Software may accordingly configure a processor, for example, to constitute a particular hardware-implemented module/component at one instance of time and to constitute a different hardware-implemented module/component at a different instance of time.

Hardware-implemented modules/components can provide information to, and receive information from, other hardware-implemented modules/components. Accordingly, the described hardware-implemented modules/components may be regarded as being communicatively coupled. Where multiple of such hardware-implemented modules/components exist contemporaneously, communications may be achieved through signal transmission (e.g., over appropriate circuits and buses that connect the hardware-implemented modules/components). In examples in which multiple hardware-implemented modules/components are configured or instantiated at different times, communications between such hardware-implemented modules/components may be achieved, for example, through the storage and retrieval of information in memory structures to which the multiple hardware-implemented modules/components have access. For example, one hardware-implemented module/component may perform an operation, and store the output of that operation in a memory device to which it is communicatively coupled. A further hardware-implemented module/component may then, at a later time, access the memory device to retrieve and process the stored output.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules/components that operate to perform one or more operations or functions. The modules/components referred to herein may, in some examples, comprise processor-implemented modules/components.

Similarly, the methods described herein may be at least partially processor-implemented. For example, at least some of the operations of a method may be performed by one or more processors or processor-implemented modules/components. The performance of certain of the operations may be distributed among the one or more processors, not only residing within a single machine, but deployed across a number of machines.

The one or more processors may also operate to support performance of the relevant operations in a “cloud computing” environment or as a “software as a service (SaaS).” For example, at least some of the operations may be performed by a group of computers (as examples of machines including processors), these operations being accessible via a network (e.g., the Internet) and via one or more appropriate interfaces (e.g., APIs).

Examples may be implemented in digital electronic circuitry, or in computer hardware, firmware, or software, or in combinations of them. Examples may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any suitable form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

FIG. 8 is a block diagram of a machine in the example form of a computer system 800 within which instructions 824 may be executed for causing the machine to perform any one or more of the methodologies discussed herein. In alternative examples, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a GPU, or both), a primary or main memory 804, and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard or a touch-sensitive display screen), a UI navigation (or cursor control) device 814 (e.g., a mouse), a storage unit 816, a signal generation device 818 (e.g., a speaker), and a network interface device 820.

As used herein, the term “processor” may refer to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor may be a multi-core processor having two or more independent processors (sometimes referred to as “cores”) that may execute instructions contemporaneously. Multi-core processors may contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor may be emulated in software, running on a physical processor, as a virtual processor or virtual circuit. The virtual processor may behave like an independent processor but is implemented in software rather than hardware.

The storage unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 or within the processor 802 during execution thereof by the computer system 800, with the main memory 804 and the processor 802 also each constituting a machine-readable medium 822.

While the machine-readable medium 822 is shown in accordance with some examples to be a single medium, the term “machine-readable medium” may include a single medium or multiple media (e.g., a centralized or distributed database, or associated caches and servers) that store the one or more instructions 824 or data structures. The term “machine-readable medium” shall also be taken to include any tangible medium that is capable of storing, encoding, or carrying instructions 824 for execution by the machine and that cause the machine to perform any one or more of the methodologies of the present disclosure, or that is capable of storing, encoding, or carrying data structures utilized by or associated with such instructions 824. The term “machine-readable medium” shall accordingly be taken to include, but not be limited to, solid-state memories, and optical and magnetic media. Specific examples of a machine-readable medium 822 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

The instructions 824 may further be transmitted or received over a communications network 826 using a transmission medium. The instructions 824 may be transmitted using the network interface device 820 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding, or carrying instructions 824 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This detailed description, therefore, is not to be taken in a limiting sense, and the scope of various examples is defined only by the appended claims, along with the full range of equivalents to which such claims are entitled.

Such examples of the subject matter may be referred to herein, individually or collectively, by the term “example” merely for convenience and without intending to voluntarily limit the scope of this application to any single example or concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. Except as otherwise indicated, the word “or” in reference to a list of two or more items, covers all of the following interpretations of the word: any one of the items in the list, all of the items in the list, and any combination of the items in the list.

Although some examples, such as those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence. The term “operation” is used to refer to elements in the drawings of this disclosure for ease of reference and it will be appreciated that each “operation” may identify one or more operations, processes, actions, or steps, and may be performed by one or multiple components.

What is claimed is:

1. A system comprising:
at least one memory that stores instructions; and
one or more processors configured by the instructions to perform operations comprising:
accessing one or more images of an inspected item and structural imaging data of the inspected item, the one or more images captured by at least one optical sensor and the structural imaging data obtained via at least one structural imaging sensor;
processing the one or more images via a first machine learning model to obtain a first defect classification;
processing at least some of the structural imaging data via a second machine learning model to obtain a second defect classification;
automatically generating, based on the first defect classification and the second defect classification, an inspection result; and
causing presentation, at a user device, of the inspection result in association with an item identifier of the inspected item.

2. The system of claim 1, wherein generating the inspection result comprises:
detecting that both the first defect classification and the second defect classification indicate that the inspected item has a defect; and
in response to detecting that both the first defect classification and the second defect classification indicate that the inspected item has a defect, generating the inspection result so as to indicate that the inspected item has one or more defects that include at least one exterior defect.

3. The system of claim 1, wherein generating the inspection result comprises:
detecting that the first defect classification indicates that the inspected item has no defects and the second defect classification indicates that the inspected item has a defect; and
in response to detecting that the first defect classification indicates that the inspected item has no defects and the second defect classification indicates that the inspected item has a defect, generating the inspection result so as to indicate that the inspected item has at least one of an interior defect or an exterior defect that was not detected from the one or more images.

4. The system of claim 1, wherein generating the inspection result comprises:
detecting that the first defect classification indicates that the inspected item has a defect and the second defect classification indicates that the inspected item has no defects; and
in response to detecting that the first defect classification indicates that the inspected item has a defect and the second defect classification indicates that the inspected item has no defects:
generating the inspection result to indicate an error; and
automatically activating an error resolution procedure that comprises triggering an additional inspection of the inspected item.

5. The system of claim 4, wherein the error resolution procedure further comprises:
receiving, from the user device, feedback regarding the error; and
automatically adjusting the inspection result based on the feedback.

6. The system of claim 5, the operations further comprising:
adjusting at least one of the first machine learning model or the second machine learning model based at least partially on the feedback.

7. The system of claim 1, wherein the inspection result is generated based on a predetermined classification algorithm that specifies respective inspection results for each of the following conditions: both the first defect classification and the second defect classification indicate that the inspected item has no defects, both the first defect classification and the second defect classification indicate that the inspected item has a defect, the first defect classification indicates that the inspected item has no defects and the second defect classification indicates that the inspected item has a defect, and the first defect classification indicates that the inspected item has a defect and the second defect classification indicates that the inspected item has no defects.

8. The system of claim 1, wherein the first defect classification and the second defect classification are binary defect classifications, and the operations further comprise at least one of:
training the first machine learning model to perform binary defect classifications on respective input images; or
training the second machine learning model to perform binary defect classifications on respective structural imaging data.

9. The system of claim 1, wherein the structural imaging data comprises first structural imaging data and second structural imaging data, the first structural imaging data being generated by the at least one structural imaging sensor to provide signal amplitude data as a time-domain signal, the operations further comprising:
processing the first structural imaging data to transform the time-domain signal to a frequency-domain signal, thereby to obtain the second structural imaging data, wherein the second structural imaging data is processed via the second machine learning model.

10. The system of claim 1, wherein the second machine learning model is one of a plurality of item-specific second machine learning models, each of the plurality of item-specific second machine learning models being trained to detect defects in a respective type of item, the operations further comprising:
identifying an item type of the inspected item; and
automatically selecting, based on the item type, the second machine learning model from the plurality of item-specific second machine learning models.

11. The system of claim 1, wherein the at least one structural imaging sensor comprises a radar apparatus.

12. The system of claim 11, wherein the radar apparatus comprises an ultra-wideband (UWB) scanner.

13. The system of claim 1, wherein the at least one optical sensor comprises a color camera.

14. The system of claim 1, wherein the system comprises the at least one optical sensor and the at least one structural imaging sensor, the operations further comprising:
using the at least one optical sensor to capture the one or more images; and
using the at least one structural imaging sensor to obtain the structural imaging data.

15. A method comprising:
accessing, by at least one processor, one or more images of an inspected item and structural imaging data of the inspected item, the one or more images captured by at least one optical sensor and the structural imaging data obtained via at least one structural imaging sensor;
processing, by the at least one processor, the one or more images via a first machine learning model to obtain a first defect classification;
processing, by the at least one processor, at least some of the structural imaging data via a second machine learning model to obtain a second defect classification;
automatically generating, by the at least one processor and based on the first defect classification and the second defect classification, an inspection result; and
causing presentation, by the at least one processor, of the inspection result in association with an item identifier of the inspected item at a user device.

16. The method of claim 15, wherein generating the inspection result comprises:
detecting that the first defect classification indicates that the inspected item has a defect and the second defect classification indicates that the inspected item has no defects; and
in response to detecting that the first defect classification indicates that the inspected item has a defect and the second defect classification indicates that the inspected item has no defects:
generating the inspection result to indicate an error; and
automatically activating an error resolution procedure that comprises triggering an additional inspection of the inspected item.

17. The method of claim 16, wherein the error resolution procedure further comprises:
receiving, from the user device, feedback regarding the error; and
automatically adjusting, by the at least one processor, the inspection result based on the feedback.

18. One or more non-transitory computer-readable media storing computer-executable instructions that, when executed by a computing system, cause the computing system to perform operations comprising:
accessing one or more images of an inspected item and structural imaging data of the inspected item, the one or more images captured by at least one optical sensor and the structural imaging data obtained via at least one structural imaging sensor;
processing the one or more images via a first machine learning model to obtain a first defect classification;
processing at least some of the structural imaging data via a second machine learning model to obtain a second defect classification;
automatically generating, based on the first defect classification and the second defect classification, an inspection result; and
causing presentation, at a user device, of the inspection result in association with an item identifier of the inspected item.

19. The one or more non-transitory computer-readable media of claim 18, wherein generating the inspection result comprises:
detecting that the first defect classification indicates that the inspected item has a defect and the second defect classification indicates that the inspected item has no defects; and
in response to detecting that the first defect classification indicates that the inspected item has a defect and the second defect classification indicates that the inspected item has no defects:
generating the inspection result to indicate an error; and
automatically activating an error resolution procedure that comprises triggering an additional inspection of the inspected item.

20. The one or more non-transitory computer-readable media of claim 19, wherein the error resolution procedure further comprises:
receiving, from the user device, feedback regarding the error; and
automatically adjusting the inspection result based on the feedback.
